(19) United States
(12) Patent Application Publication
(10) Pub. No.: US 2014/0083552 A1
(43) Pub. Date: Mar. 27, 2014

(54) INK COMPOSITION AND PROCESS FOR PRINTING ON LAMINATES

(71) Applicants: Avinash Velandy Mukkolath, Mumbai (IN); Mrinal Kanti Banerjee, Mumbai (IN)

(72) Inventors: Avinash Velandy Mukkolath, Mumbai (IN); Mrinal Kanti Banerjee, Mumbai (IN)

(73) Assignee: ESSEL PROPACK LTD., Mumbai (IN)

(21) Appl. No.: 14/117,794

(22) PCT Filed: Jun. 5, 2012
(86) PCT No.: PCT/IN2012/000397

§ 371 Date: Dec. 6, 2013

(30) Foreign Application Priority Data
Jun. 6, 2011 (IN) 1648/MUM/2011

(51) Int. Cl. C09D 11/02; F16L 9/14

(52) U.S. Cl. CPC C09D 11/02; F16L 9/14
USPC 138/151; 106/31.6; 101/483

(57) ABSTRACT

The present disclosure relates to an ink composition for printing an outer layer of a laminate. The present disclosure provides an ink composition for printing on a laminate, comprising: a printing ink; and an additive; wherein the printing ink and the additive is in a ratio of 70:30 to 95:5 (wt/wt), and the additive is a translucent to transparent extender that reduces the pigment solid content in the ink composition by 50%-95%. The present disclosure further provides a process for printing the outer layer of a laminate including the seam area of the laminate with the ink composition, more preferably, for achieving a 360 degree printing effect over the laminated tube formed by the laminate.

### TECHNICAL FIELD

The present disclosure relates to an ink composition for using on laminates. The present disclosure further relates to a printing method on laminates using said ink composition.

More particularly, the ink composition can be used on the seam portion of the laminated article, such as laminated tubes, without causing any damage to the seam portions by which a 360 degree printing effect is achieved over a laminated article (tube) formed by the laminate.

### BACKGROUND

During the process of manufacturing laminated tubes, the laminate is slit according to the size of the tube to be manufactured. Once the laminate is slit into smaller laminates of appropriate size, the outer layer of the laminates are printed. Before printing, the outer layer of the laminate is pre-treated, for example, by corona treatment, to prepare the outer surface for better adherence of the inks. Further, the printed laminate is rolled into a laminated tube by fusing together the longitudinal ends of the laminate.

Typically, while performing such printing, a non-printed area or a non-printed strip is left over the outer layer of the laminate and along the longitudinal ends of the laminate. Then the longitudinal ends of the laminate are fused by hermetically sealing the non printed strips together to form a seam of the tube. The reason of achieving the non-printed strips is that the over varnish and the printing ink is prone to contaminate and damage the seam area, which is actually an overlapped area or an intersection of the two non-printed strips. However, the presence of varnish is necessary on the printing ink as the varnish provide scuff resistance and chemical resistance to the ink.

As a result, the non-printed strips of the laminate restrict the area of printing in the laminate, thereby restricting a printed curved surface area of the laminated tube, and compromising with the aesthetics of the tube.

Hence, there is a need for providing an ink composition to facilitate printing over the seam area of the laminates.

### SUMMARY

The present disclosure provides an ink composition for printing an outer layer of a laminate. The ink composition facilitates a 360 degree printing over a laminated article, such as a laminated tube formed by the laminate, which means the ink composition can be used for printing over the seam area also of the laminated article (tube).

The present disclosure provides an ink composition for printing on a laminate, comprising: a printing ink; and an additive; wherein the printing ink and the additive is in a ratio of 70:30 to 95:5 (wt/wt), and the additive is a translucent to transparent extender that reduces the pigment solid content in the ink composition by 50%-95%.

The present disclosure further provides a process for printing the outer layer of a laminate including the longitudinal ends that forms the seam area of the laminated article (such as laminated tube) formed by the laminate, with the ink composition, for achieving a 360 degree printing over the laminated article (tube).

These and other features, aspects, and advantages of the present disclosure will become better' understood with reference to the following description. This statement is provided to introduce a selection of concepts in a simplified form. This statement is not intended to identify key features or essential features of the subject matter, nor is it intended to be used to limit the scope of the subject matter.

### DETAIL DESCRIPTION

The present disclosure provides an ink composition for printing an outer layer of a laminate. The ink composition facilitates printing throughout the area of the outer layer of the laminate. This further facilitates a 360 degree printing of a laminated article, such a laminated tube including the seam area of the laminated article (tube).

The present disclosure provides an ink composition for printing on a laminate, comprising: a printing ink; and an additive; wherein the printing ink and the additive is in a ratio of 70:30 to 95:5 (wt/wt), and the additive is a translucent to transparent extender that reduces the pigment solid content in the ink composition by 50%-95%.

In printed laminated articles, such as laminated tubes or lamitubes', it is generally seen that the seam portion is not printed. This is because the varnish and lacquers present in the printing ink interferes with the sealability, thereby damaging the seam. The ink composition of the present disclosure can be advantageously used for printing over the entire laminate, so that the laminated article or tube made of the laminate has printing over the seam area also. The ink composition with the additive enables the printing throughout the area of the outer layer of the laminate. Specifically, the additive in the ink composition substantially removes silicone and waxes present in the ink. By the term “substantially removes silicone and waxes” in accordance with the present disclosure refers to the total absence of silicone and waxes in the ink composition, or near total absence such as 99% to 95% removal, or 50% to 95% removal.

In addition, the additive in the ink composition acts as a thinning agent to lessen the ink density or pigment concentration of the ink by about 50%. In the resultant diluted ink composition, pigment solid content is from 5% to 50%, which means the pigment solid content is reduced by 50% to 95%. This removal and lessening of the ink density facilitates application of the ink composition with the additive throughout the outer layer of the laminate without leaving any unprinted strip. Accordingly, no non-printed strips along the longitudinal ends are retained within the laminate.

An embodiment of the present disclosure provides an ink composition for printing on a laminate, comprising: a printing ink; and an additive; wherein the printing ink and the additive is in a ratio of 90:10 (wt/wt), and the additive is a translucent to transparent extender that reduces the pigment solid content in the ink composition by 50%-95%.

In accordance with the present disclosure, the additive is an extender, preferably a translucent to transparent extender which is an inert mineral pigment of low opacity that reduces the pigment solid content in the ink composition by 50%-95%. An extender is used to provide lighter concentration of the ink and reduce silicones, waxes present in the ink. Further, the additive, in accordance with the present disclosure, is an agent that lightens the thickness of the ink and is compatible with any color of the printing ink.

The additive can be notably commercially available extenders such as “Transparent white” from Siegwerk.

Another embodiment of the present disclosure provides an ink composition for printing on a laminate, comprising: an ultra violet curable letterpress printing ink; and an additive; wherein the ultra violet curable letterpress printing ink and the additive is in a ratio of 70:30 to 95:5 (wt/wt), and the additive is a translucent to transparent extender that reduces the pigment solid content in the ink composition by 50%-95%.

Yet another embodiment of the present disclosure provides an ink composition for printing on a laminate, comprising: a flexo printing ink; and an additive; wherein the flexo printing ink and the additive is in a ratio of 70:30 to 95:5 (wt/wt), and the additive is a translucent to transparent extender that reduces the pigment solid content in the ink composition by 50%-95%.

In accordance with the present invention, the ink used in the composition, like the ultra violet curable letterpress printing ink or flexo printing ink employed can be of any color and may be provided by various printing ink manufacturing units like SIEGWERK, Sun Chemicals, Flint Group etc. for printing laminates.

Still another embodiment of the present disclosure provides an ink composition for printing on a laminate, comprising: a printing ink; and an additive; wherein the printing ink and the additive is in a ratio of 70:30 to 95:5 (wt/wt), and the additive is an extender which is a translucent to transparent extender of low opacity that reduces the pigment solid content in the ink composition by 50%-95%.

Yet another embodiment of the present disclosure provides an ink composition for printing on a laminate, comprising: a printing ink; and an additive; wherein the printing ink and the additive is in a ratio of 70:30 to 95:5 (wt/wt), and the additive is an extender which is an inert mineral pigment of low opacity that reduces the pigment solid content in the ink composition by 50%-95%.

Further an embodiment of the present disclosure provides an ink composition for printing on a laminate, comprising: a printing ink; and an additive; wherein the printing ink and the additive is in a ratio of 70:30 to 95:5 (wt/wt), and the additive is a translucent to transparent extender that reduces the pigment solid content in the ink composition by 50%-95% for use in printing of a laminate over the whole surface area of the laminate including the longitudinal ends capable of forming seam when fused together.

Yet another embodiment of the present disclosure provides an ink composition for printing on a laminate, comprising: a printing ink; and an additive; wherein the printing ink and the additive is in a ratio of 70:30 to 95:5 (wt/wt), and the additive is a translucent to transparent extender that reduces the pigment solid content in the ink composition by 50%-95% and wherein said laminate is made into a laminated tube comprising of a printed surface area including the longitudinal seam, wherein the printed surface area is printed with the ink composition.

The present disclosure provides a process for printing the outer layer of a laminate including the seam area of the laminate with the ink composition comprising: modifying a printing plate to form 50% dots of nylon polymer on a nyloplate; clipping the printing plate to a cylindrical drum to form a rotary printing plate; applying the ink composition for printing comprising: a printing ink; and an additive; wherein the printing ink and the additive is in a ratio of 70:30 to 95:5 (wt/wt), and the additive is a translucent to transparent extender that reduces the pigment solid content in the ink composition by 50%-95%, over the rotary printing plate; and rotating the printing plate over the outer layer of the laminate to print the laminate including the seam area of the laminate.

The process of printing, in accordance with the present disclosure, provides modification of a plate graphic system of a printing plate of an ultra violet rotary letterpress printing machine and employing the modified ink of the present disclosure, within the letterpress printing machine to print the outer layer of the laminate including the seam area of the laminate. Specifically, during a preparation stage of the printing plates (prepress stage), negative films of a content to be printed is corrected and about 50% screen percentage is given on a content area (or an image area). This facilitates about 50% dots of nylon polymer on a nyloplate after its formation. Such kind of nyloplate or polymer plate acts as the printing plate and facilitates a release of about 50% of the printing inks transfer on the outer layer of the laminate. Once the ink impression is transferred to the laminate, it is fully cured or dried with the help of Intense UV rays (275 to 375 nm and 60 to 120 watt/cm energy). The polymer surface do not really adsorb the ink composition, rather it get polymerized under the exposure of Intense UV rays and gets strongly bonded with the polymer substrate.

An embodiment of the present disclosure provides a process for printing the outer layer of a laminate including the seam area of the laminate with the ink composition, the said ink composition is applied over the entire outer layer of the laminate including the seal portion of the laminate.

The addition of the additive facilitates avoiding of varnish within the ink. The ink mixed with the aforementioned additive can be used for printing on the sealed potion of the laminate effectively and it would not cause any adverse effect to the seal portion. As a result, the printed longitudinal ends of the laminate are capable of forming the seam within the laminated tube on fusing these ends together.

Another embodiment of the present disclosure provides a process for printing the outer layer of a laminate including the seam area of the laminate with the ink composition for printing on a laminate, comprising: modifying a printing plate to form 50% dots of nylon polymer on a nyloplate; clipping the printing plate to a cylindrical drum to form a rotary printing plate; applying the ink composition for printing comprising: a printing ink; and an additive; wherein the printing ink and the additive is in a ratio of 90:10 (wt/wt), and the additive is a translucent to transparent extender that reduces the pigment solid content in the ink composition by 50%-95%, over the rotary printing plate; and rotating the printing plate over the outer layer of the laminate is printed including the seam area is sealed with a high frequency or heat and pressure sealing.

After the printing of the laminate has been accomplished by the ink mixed with the additive, the varnish may be applied on the entire outer layer of the laminate, except the seam portion of the laminate. Such application of the varnish after the printing is necessary to get better scuff resistance and chemical resistance to the ink that is done over the outer layer of the laminate.

Further an embodiment of the present disclosure provides a process for printing the outer layer of a laminate including the seam area of the laminate with the ink composition, a 360 degree printing effect is achieved over the laminated tube formed by the laminate.

The disclosure will now be illustrated with working examples, which is intended to illustrate the working of disclosure and not intended to take restrictively to imply any limitations on the scope of the present disclosure.

### EXAMPLE 1

An ink composition is prepared by combining about 70:30 to 95:5 wt/wt of an ultra violet curable letterpress ink or a flexo printing ink with translucent to transparent extender.

### EXAMPLE 2

An ultra violet curable letterpress ink or a flexo printing ink is combined with ultra violet transparent white based additive in ratio of 90:10 wt/wt to obtain the ink composition.

### EXAMPLE 3

For the printing of a laminate by the ink composition of the present disclosure, the plate graphic system of a printing plate of an Ultra violet rotary letterpress printing machine is modified, such that negative films of a content to be printed is corrected and about 50% screen percentage is given on a content area (or an image area).

This facilitates about 50% dots of nylon polymer on a nyloplate after its formation and facilitates release of about 50% of the printing inks transfer on the outer layer of the laminate. The ink impression is then transferred to the laminate. The laminate is fully cured or dried with the help of Intense UV rays (275 to 375 nm and 60 to 120 watt/cm energy), once the ink impression is transferred.

As a result of modification of the graphic system of the printing plate and the usage of modified ink, the entire outer layer of the laminate including the whole longitudinal length of the laminate gets printed and a 360 degree printing effect can be achieved over the laminated tube formed by the laminate.

### EXAMPLE 4

The 360 degree printed laminate tubes are formed by placing the rolls of the printed laminate material onto the needles of the tubing machine. The material is then taken in a flat state and fed through the forming rolls, which very gently turn the tube and form it into a cylinder of variable size depending on the customer's needs. Heat generated by high frequency fuses the sides of the material together to form a solid cylindrical tube. After the tube has been formed, it goes to the cutting station that slices it into various lengths. The desired tube of cylindrical shape and length is transferred to the heading operation. As with plastic tubes, several heading methodologies are available. One particular method uses a preformed head. The tube is then placed onto a mandrel, the preformed head and shoulder are fed down vibrator shoots and fused to the top of the tube by means of heat generated by high frequency energy.

Other methodologies apply the head to the sleeve in a similar manner to plastic tubes—either by injection or compression molding whereby heat fuses the head to the tube body. After the complete tube has been formed, it goes to the capping station. The cap flat style, fez style or pedestal style is chosen based on the customer's needs. The cap is applied and torqued to the desired torquing requirements. The tube is then ejected onto a conveyor and taken to a packing operation where it is packed into a carton and is ready for the customer.

Although the subject matter has been described in considerable detail with reference to certain preferred embodiments thereof, other embodiments are possible. As such, the spirit and scope of the invention should not be limited to the description of the preferred embodiment contained therein.

1. An ink composition for printing on a laminate, comprising:
a printing ink; and
an additive;
wherein the printing ink and the additive is in a ratio of 70:30 to 95:5 (wt/wt), and the additive is a translucent to transparent extender that reduces the pigment solid content in the ink composition by 50%-95%.

2. The ink composition as claimed in claim 1, wherein the printing ink and the additive is in a ratio of 90:10 (wt/wt).

3. The ink composition as claimed in claim 1, wherein the printing ink is an ultra violet curable letterpress or flexo printing ink.

4. The ink composition as claimed in claim 1, wherein the extender is a translucent to transparent, inert mineral pigment of low opacity.

5. The ink composition as claimed in claim 1, wherein the ink composition is use in printing of a laminate over the whole surface area of the laminate including the longitudinal ends capable of forming seam when fused together.

6. A laminated tube comprising of a printed surface area including the longitudinal seam, wherein the printed surface area is printed with an ink composition comprising:
a printing ink; and
an additive:
wherein the printing ink and the additive is in a ratio of 70:30 to 95:5 (wt/wt) and the additive is a translucent to transparent extender that reduces the pigment solid content in the ink composition by 50%-95%.

7. A process for printing the outer layer of a laminate including the seam area of the laminate with the ink composition as claimed in any of the claims 1-4, said process comprising:
modifying a printing plate to form 50% dots of nylon polymer on a nyloplate;
clipping the printing plate to a cylindrical drum to form a rotary printing plate;
applying an ink composition for printing comprising a printing ink; and an additive; wherein the printing ink and the additive is in a ratio of 70:30 to 95:5 (wt/wt), and the additive is a translucent to transparent extender that reduces the pigment solid content in the ink composition by 50%-95%, over the rotary printing plate; and
rotating the printing plate over the outer layer of the laminate to print the laminate including the seam area of the laminate.

8. The process as claimed in claim 7, wherein the said ink composition is applied over the entire outer layer of the laminate including the seal portion of the laminate.

9. The process as claimed in claim 7, wherein the laminate is printed including the seam area is sealed with a high frequency or heat and pressure sealing.

10. The process as claimed in claim 7, wherein a 360 degree printing effect is achieved over the laminated tube formed by the laminate.
